(19) United States
(12) Patent Application Publication
(10) Pub. No.: US 2024/0349739 A1
(43) Pub. Date: Oct. 24, 2024

(54) Place and Bake Cake Product

(71) Applicant: General Mills, Inc., Minneapolis, MN (US)

(72) Inventors: Susan Y. deWerff, Minnetonka, MN (US); David J. Domingues, Plymouth, MN (US); Charles Stephen Lucas, Minneapolis, MN (US); Michelle Tollefson, Lakeville, MN (US)

(73) Assignee: General Mills, Inc., Minneapolis, MN (US)

(21) Appl. No.: 18/687,362

(22) PCT Filed: Sep. 23, 2022
(86) PCT No.: PCT/US2022/044497

§ 371 Date: Feb. 28, 2024

Related U.S. Application Data
(60) Provisional application No. 63/249,243, filed on Sep. 28, 2021.

(51) Int. Cl. A21D 10/02; A21D 2/18; A21D 6/00

(52) U.S. Cl. CPC A21D 10/025; A21D 2/183; A21D 2/186; A21D 6/001

(57) ABSTRACT

A refrigerated or frozen place-and-bake cake product is described that includes an uncooked dough that has handling characteristics that allow for convenient placement on a baking sheet for baking, yet also results in a cake-like texture upon baking. The uncooked dough includes a particular combination of wheat flour and corn flour, pregelatinized starch and/or a fruit or vegetable puree or mash, a gum component that includes xanthan gum and at least one other gum, sucrose, egg solids, dairy solids, and a leavening system.

### BACKGROUND

Consumers enjoy home baked food, but often lack the time necessary to prepare and bake such foods. Refrigerated and frozen dough products that consumers simply place on a baking sheet and put in the oven to cook before eating (place-and-bake dough products) can provide both convenience and an eating experience reminiscent of a baked food made from scratch.

### SUMMARY

The present disclosure relates to a place and bake cake product.

A refrigerated or frozen place-and-bake cake product is provided herein. A refrigerated or frozen place-and-bake cake product includes portions of an uncooked dough with a water activity of less than 0.85, where the uncooked dough has a dough phase in an amount of about 75% to 100%. A dough phase of a refrigerated or frozen place-and-bake cake product can include a flour component, the flour component comprising wheat flour in an amount of about 11% to about 22% by weight of the dough phase and corn flour in an amount of about 6.5% to about 13% by weight of the dough phase; a pregelatinized starch component in an amount of about 0.4% to about 3.3% by weight of the dough phase; a gum component in an amount of at least 0.07% to about 0.33% by weight of the dough phase, the gum component comprising xanthan gum and a second gum; a fat content of from about 12% to about 20% by weight of the dough phase, the fat content comprising a fat that is solid at room temperature; sucrose in an amount of at least 15% by weight of the dough phase; an egg solids component in an amount of from about 0.8% to about 2.4% by weight of the dough phase, the egg component comprising egg white solids in an amount of about 0.7% to about 1.5% by weight of the dough phase; a dairy solids component in an amount of about 3% to about 10% by weight of the dough phase; a leavening system in an amount of from about 0.4% to about 0.7% by weight of the dough phase; and a moisture content of from about 15% and about 25% by weight of the dough phase. In some embodiments, the second gum can include carrageenan and/or locust bean gum. In some embodiments, the xanthan gum and the second gum can be included at a weight ratio of about 1:2 to about 1:3 xanthan gum to second gum. In some embodiments, the second gum can include carrageenan gum and locust ban gum at a weight ratio of about 1:0.5 to 1:1 carrageenan gum to locust bean gum. In some embodiments, at least a portion of the moisture content can be provided by a fruit or vegetable mash or puree, such as banana puree or mash, zucchini puree or mash, apple puree or mash, or pumpkin puree or mash. In some embodiments, the dough phase can include an emulsifier in an amount of, for example, about 0.5% to about 2.5% by weight of the dough phase. In some embodiments, the dough phase can include potato starch and/or soluble corn fiber, e.g., in an amount of up to 3% by weight of the dough phase.

In some embodiments, a dough phase can include a flour component, the flour component comprising wheat flour in an amount of about 11% to about 22% by weight of the dough phase and corn flour in an amount of about 6.5% to about 13% by weight of the dough phase; a fruit or vegetable mash or puree in an amount of about 5% to about 18% by weight of the dough phase; a gum component in an amount of at least 0.07% to about 0.33% by weight of the dough phase, the gum component comprising xanthan gum and a second gum; a fat content of from about 12% to about 20% by weight of the dough phase, the fat content comprising a fat that is solid at room temperature; sucrose in an amount of at least 15% by weight of the dough phase; an egg solids component in an amount of from about 0.8% to about 2.4% by weight of the dough phase, the egg solids component comprising egg white solids in an amount of about 0.7% to about 1.5% by weight of the dough phase; a dairy solids component in an amount of about 3% to about 10% by weight of the dough phase; a leavening system in an amount of from about 0.4% to about 0.7% by weight of the dough phase; and a moisture content of from about 15% and about 25% by weight of the dough phase. In some embodiments, the xanthan gum and the second gum can be included at a weight ratio of about 1:2 to about 1:3 xanthan gum to second gum. In some embodiments, the second gum can include carrageenan gum and locust ban gum at a weight ratio of about 1:0.5 to 1:1 carrageenan gum to locust bean gum. In some embodiments, at least a portion of the moisture content can be provided by a fruit or vegetable mash or puree, such as banana puree or mash, zucchini puree or mash, apple puree or mash, or pumpkin puree or mash. In some embodiments, the dough phase can include an emulsifier in an amount of, for example, about 0.5% to about 2.5% by weight of the dough phase. In some embodiments, the dough phase can include potato starch and/or soluble corn fiber, e.g., in an amount of up to 3% by weight of the dough phase.

In some embodiments, an uncooked dough of a refrigerated or frozen place-and-bake cake product provided herein can include particulates in an amount of up to 20% by weight of the uncooked dough distributed throughout the dough phase.

In some embodiments, portions of an uncooked dough of a refrigerated or frozen place-and-bake cake product provided herein can be from about 20 g to about 40 g. In some embodiments, the portions can be packaged with two or more portions in a package. In some embodiments, the portions can be separately packaged. In some embodiments, the portions can be packaged on a disposable support surface.

A method of making a refrigerated or frozen place-and-bake cake product is also provided herein. The method can include combining a flour component and a gum component with wet ingredients to form a first mixture, where the flour component comprises wheat flour and corn flour, the gum component comprises xanthan gum and a second gum, and the wet ingredients comprise water, a fruit or vegetable mash or puree, or any combination thereof; combining the first mixture with dry ingredients to form a second mixture, the second mixture comprising sucrose, an egg solids component, a dairy solids component, and a leavening system; combining the second mixture with a fat that is solid at room temperature to produce an uncooked dough having a dough phase with a water activity of less than 0.85; forming the uncooked dough into portions; packaging the portions; and refrigerating or freezing the packaged portions to produce the refrigerated or frozen place-and-bake cake product. The dough phase includes wheat flour in an amount of about 11% to about 22% by weight of the dough phase; corn flour in an amount of about 6.5% to about 13% by weight of the dough phase; a pregelatinized starch component or the fruit or vegetable mash or puree; the gum component in an amount of at least 0.07% to about 0.33% by weight of the dough phase; a fat content of from about 12% to about 20% by weight of the dough phase, the fat content comprising the fat that is solid at room temperature; sucrose in an amount of at least 15% by weight of the dough phase; the egg solids component in an amount of from about 0.8% to about 2.4% by weight of the dough phase, the egg solids component comprising egg white solids in an amount of about 0.7% to about 1.5% by weight of the dough phase; the dairy solids component in an amount of about 3% to about 10% by weight of the dough phase; the leavening system in an amount of from about 0.4% to about 0.7% by weight of the dough phase; and a moisture content of from about 15% and about 25% by weight of the dough phase. If included, the pregelatinized starch component can be included in an amount of about 0.4% to about 3.3% by weight of the dough phase. In some embodiments, the dry ingredients used in the second mixture can include the pregelatinized starch component. If included, the fruit or vegetable mash or puree can be included in an amount of about 5% to about 18% by weight of the dough phase. In some embodiments, the first mixture can include corn starch and/or glycerin.

In some embodiments of a method of making a refrigerated or frozen place-and-bake cake product, one or more of the combining steps can be performed at a temperature of about 60° F. to about 80° F.

In some embodiments of a method of making a refrigerated or frozen place-and-bake cake product, the uncooked dough can include particulates distributed throughout the dough phase. In some embodiments, the particulates can be combined with the first mixture to make the second mixture. In some embodiments, the particulates can be combined with the second mixture before combining with the fat that is solid at room temperature. In some embodiments, the particulates can be combined with the dough phase to make the uncooked dough.

In some embodiments of a method of making a refrigerated or frozen place-and-bake cake product, the portions can be refrigerated or frozen before packaging. In some embodiments of a method of making a refrigerated or frozen place-and-bake cake product, the portions can be refrigerated or frozen after packaging.

These and various other features and advantages will be apparent from a reading of the following detailed description.

### DRAWINGS

FIG. 1 is a series of pictures illustrating open crumb structure, following baking and cutting to show a cross-section, of an embodiment of a place-and-bake cake product (muffin top) described herein (upper left), as compared to a dense crumb structure of a place-and-bake brownie product (upper right), and a place-and-bake cookie product (bottom center).

FIG. 2 is a series of pictures illustrating a smooth, cake-like surface, following baking, of an embodiment of a place-and-bake cake product (muffin top) described herein (left), as compared to a dry, cracked surface of a place-and-bake cookie product (right).

FIG. 3 is a graph comparing Springiness of baked goods made from an embodiment of a place-and-bake cake product (muffin top) described herein, a place-and-bake brownie product, and a place and bake cookie product, as measured by a texture analyzer.

FIG. 4 is a graph comparing Resilience of baked goods made from an embodiment of a place-and-bake cake product (muffin top) described herein, a place-and-bake brownie product, and a place and bake cookie product, as measured by a texture analyzer.

FIG. 5 is a graph comparing Chewiness of baked goods made from an embodiment of a place-and-bake cake product (muffin top) described herein, a place-and-bake brownie product, and a place and bake cookie product, as measured by a texture analyzer.

### DETAILED DESCRIPTION

Place-and-bake dough products provide a way for consumers to have fresh-baked cookies, biscuits, and brownies without having to prepare a dough or batter, or having to wait for a dough or batter to thaw and/or rise prior to cooking. However, refrigerated dough products that can be baked to produce a cake-like product generally fail to have handling characteristics that enable convenient placement on a baking sheet prior to cooking, or they fail to achieve an eating experience that resembles a cake product made from scratch.

It was discovered, and is disclosed herein, that a unique blend of components can be combined to make a place-and-bake cake product that has good handleability, a low water activity (e.g., less than 0.85), and a long refrigerated shelf life (e.g., greater than 2 months, greater than 3 months, or at least 4 months at 4° C.) while uncooked, yet produces a cake-or muffin-like texture upon baking. This was particularly surprising because it was previously believed that limiting water activity inhibited starch hydration during the baking process, which was believed to be required for a moist, springy, muffin-like texture. Thus, it was previously believed that a moist, springy, cake-or muffin-like texture could only be achieved using a dough with a high water activity, sometimes higher than 0.90, which not only resulted in a poor refrigerated shelf life, but also resulted in a soft, sticky dough that was hard to handle.

A further benefit of the disclosed place-and-bake product is that the described blend of components can, in some embodiments, also develop a dome-like appearance upon baking that resembles the top of a muffin to produce a unique place-and-bake muffin top product.

A refrigerated or frozen place-and-bake cake product is described herein. As used herein, the term “place-and-bake” refers to a pre-portioned refrigerated or frozen uncooked dough that can be immediately baked upon removal from a refrigerator or freezer. Such place-and-bake products are typically removed from packaging and placed on a baking surface prior to baking, but can, in some embodiments, be packaged on a disposable support that is suitable for use as a baking surface. In some embodiments, a frozen place-and-bake dough can be thawed prior to baking, though thawing need not achieve any particular temperature prior to baking other than to provide for a dough that is no longer frozen (e.g., is pliable). A particular benefit to a place-and-bake cake product provided herein is that the pre-portioned uncooked dough has good handling characteristics (e.g., is not sticky to the touch, is firm enough to pick up without significant deformation) when in a thawed state.

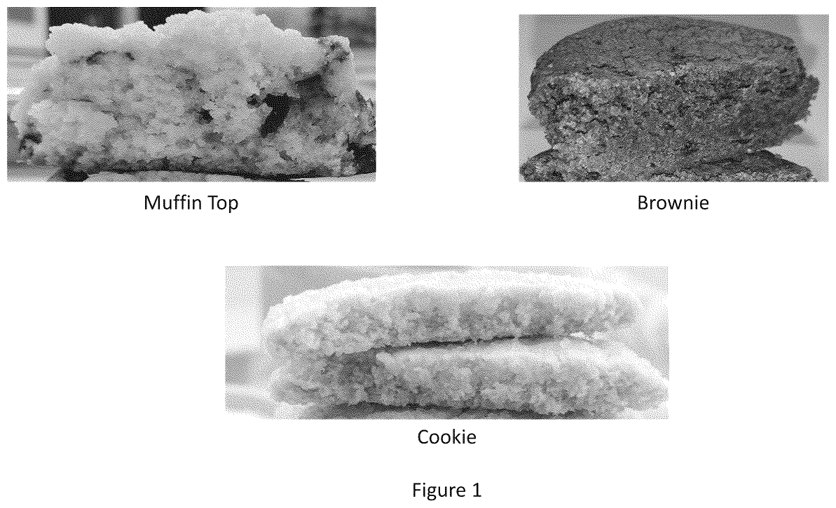

As used herein, the term “cake” refers to a baked good, such as a cake, a muffin, a cupcake, a muffin top, and the like, that has an open crumb structure (see, FIG. 1), and a soft, moist, springy texture. In contrast, brownie texture is typically chewy and dense, with little springiness, and cookies are typically denser, harder, crunchy or crispy, and have little springiness.

A refrigerated or frozen place-and-bake cake product provided herein includes portions of an uncooked dough with a water activity of less than 0.86 (e.g., 0.75 to 0.855). The uncooked dough includes a dough phase and, optionally, particulates distributed within or throughout the dough phase.

The dough phase of a refrigerated or frozen place-and-bake cake product includes a flour component. A flour component typically includes a combination of a wheat flour and a corn flour. A wheat flour can be included in a dough phase in an amount of about 11% to about 22% (e.g., about 14% to about 20%) by weight of the dough phase. Wheat flour can contribute to structure of a place-and-bake cake product once baked. Wheat flour can contribute bulk and cohesiveness to a refrigerated or frozen place-and-bake cake product.

Corn flour can be included in a dough phase in an amount of about 6% to about 14% (e.g., about 6.5% to about 13%, or about 8% to about 11%) by weight of the dough phase. Corn flour can contribute to handle ability of uncooked dough of a place-and-bake cake product, and texture of the product once baked. For example, corn flour included in an amount of less than 6% by weight of a dough phase can result in a dough that is too sticky to handle with case, even though the baked product might have a good structure and texture. On the other hand, if more than 14% by weight of a dough phase in a place-and-bake cake product is corn flour, the texture of the product once baked can be gritty and/or dry.

The dough phase of a refrigerated or frozen place-and-bake cake product can include a pregelatinized starch component in an amount of up to 4% (e.g., about 0.4% to about 3.5%, about 0.5% to about 2.5%) by weight of the dough phase. Pregelatinized starch can include any one or a combination of gelatinized starches, such as corn starch, potato starch, and the like. Pregelatinized starch content can contribute to handleability and shelf life of uncooked dough of a place-and-bake cake product, and texture and/or mouthfeel of the product once baked. For example, too little pregelatinized starch in the dough phase of a place-and-bake cake product can result in the uncooked dough being sticky and/or tacky, while too much pregelatinized starch can result in hardening of the uncooked dough over shelf life and/or dryness and/or grittiness of the product once baked.

In some embodiments, additional starch included in a dough phase can be provided by a vegetable or fruit mash or puree (e.g., banana, pumpkin, zucchini, apple, and the like). Starch included in a vegetable or fruit mash or puree need not be pregelatinized. For example, in some embodiments, a dough phase can contain about 0.4% to about 4% (e.g., about 0.5% to about 3%, or about 1% to about 2.5%) by weight pregelatinized starch and about 5% to about 18% (e.g., about 7% to about 12%, or about 8% to about 10%) banana puree. An amount of a selected fruit or vegetable puree or mash can be adjusted based on starch content of the puree or mash, water content of the puree or mash, desired flavor of the resulting product, and/or other factors, such as nutritional content (e.g., fiber, mineral, and/or vitamin content), and the like.

In some embodiments, the amount of a pregelatinized starch component in dough phase of a refrigerated or frozen place-and-bake cake product can be reduced or eliminated if a vegetable or fruit mash or puree is included in the dough phase. That is, in some embodiments, a dough phase can contain less than 0.4% (e.g., less than 0.2%, or 0%) by weight pregelatinized starch component and about 5% to about 18% (e.g., about 7% to about 12%, or about 8% to about 10%) vegetable or fruit mash or puree (e.g., banana, pumpkin, zucchini, apple, and the like).

The dough phase of a refrigerated or frozen place-and-bake cake product includes a gum component in an amount of at least 0.07% to about 0.33% (e.g., about 0.1% to about 0.28%) by weight of the dough phase. A gum component includes xanthan gum and a second gum. Xanthan gum in a dough phase of a place-and-bake cake product can aid in supporting structure from other gums included in the dough phase. Xanthan gum can be included in the dough phase of a place-and-bake cake product in an amount of about 0.07% to about 0.2% (e.g., about 0.07% to about 0.15%, or about 0.08% to about 0.1%) by weight of the dough phase.

The second gum of a gum component can include one or any combination of carrageenan gum and locust bean gum. The second gum of a gum component in the dough phase of a place-and-bake cake product can contribute to a good ratio of rise to spread of a baked good made with the product. In some embodiments, a second gum comprising carrageenan gum and/or locust bean gum can contribute to a domed shape that resembles the top of a muffin when baked to produce a unique place-and-bake muffin top product.

A gum component in the dough phase of a place-and-bake cake product provided herein typically includes xanthan gum and a second gum at a ratio of about 1:2 to about 1:3 xanthan gum to second gum. In embodiments where the second gum comprises carrageenan gum and locust bean gum, the ratio of amount of carrageenan gum to the amount of locust bean gum is typically about 1:0.5 to about 1:1.

It was discovered that a gum component disclosed herein can contribute to handleability and shelf life of uncooked dough of a place-and-bake cake product, and structure of the product once baked. For example, it was found that a gum component content of greater than 0.33% resulted in hardening of uncooked dough of a place-and-bake cake product over shelf life. An amount of a gum component in a place-and-bake cake product that is less than 0.07% by weight of the dough phase can result in an uncooked dough that is sticky and too soft to handle and a structure upon baking that flat with an undesirably open crumb structure.

The dough phase of a refrigerated or frozen place-and-bake cake product includes a fat content of from about 12% to about 20% (e.g., about 14% to about 18%) by weight of the dough phase. Typically, at least a portion (e.g., at least 50%, at least 75%, or 100%) of the fat content in a dough phase is a solid fat at room temperature. In some embodiments, fat content in a dough phase can comprise a shortening. For the purposes of this disclosure, a shortening is generally considered a fat that is solid at room temperature, even if it contains one or more fat that is otherwise not solid at room temperature (e.g., canola oil, soybean oil, sunflower oil, and the like). Too much fat content can result in an exterior that looks too smooth and an eating texture that is creamy rather than cake-like. In contrast, too little fat can result in a dry eating texture and too little spread during baking.

In some embodiments, a dough phase of a refrigerated or frozen place-and-bake cake product can include an oil (e.g., canola oil, soybean oil, sunflower oil, and the like) to reduce stickiness of a dough phase. For example, a dough phase can contain up to 5% (e.g., about 1% to about 4%, or about 1% to about 3%) by weight oil.

The dough phase of a refrigerated or frozen place-and-bake cake product includes added sugar (e.g., sucrose, dextrose, other sugars, or any combination thereof) in an amount of at least 15% (e.g., about 16% to 30%, or about 17% to about 23%) by weight of the dough phase. Sugar can provide sweetness and contribute to structure of a place-and-bake cake product upon baking. In addition, sugar can help reduce water activity in the uncooked dough of a place-and-bake cake product. It is to be understood that “added sugar” refers to concentrated and/or purified sugar sources, such as table sugar, syrups, and the like. A fruit or vegetable puree or mash, or dairy solids components may contain sugars, but are not considered added sugar.

The dough phase of a refrigerated or frozen place-and-bake cake product includes an egg solids component in an amount of from about 0.8% to about 2.4% (e.g., about 0.8% to about 2.0%) by weight of the dough phase, where the egg component includes egg white solids in an amount of about 0.6% to about 1.5% (e.g., about 0.6% to about 1.2%) by weight of the dough phase. An egg solids component can contribute to rise and setting of a structure of a place-and-bake cake product upon baking, with an excess of egg white relative to whole egg providing a particularly desirable amount of height upon baking. An amount of egg solids component that is less than 0.8% can result in a structure that is too dense, resembling a brownie or cookie in crumb structure (see, FIG. 1), while an amount of egg solids component that is greater than 2.4% can result in a structure that is firmer than desired, and/or a mouthfeel that is too dry. An amount of egg solids component that is from about 0.8% to about 1.2% can help to preserve over shelf life an amount of spreading during baking, such that the baked product is more dome-like for a muffin top product.

An egg solids component can include any ingredient that contributes egg solids, including whole egg, whole dried egg, egg white, dried egg white, egg yolk, dried egg yolk, or any combination thereof. Particularly useful is a combination of whole dried egg and dried egg white. It is to be understood that whole egg and whole dried egg comprises a portion of egg white solids. Generally, dried whole egg contains about 30% to about 40% by weight egg white solids.

The dough phase of a refrigerated or frozen place-and-bake cake product includes a dairy solids component in an amount of about 3% to about 10% (e.g., about 4% to about 8%) by weight of the dough phase. A dairy solids component can contribute flavor, color, and/or bulk, without contributing significantly to a dry mouthfeel of a baked good made from a place-and-bake cake product.

A dairy solids component can include any ingredient that contributes dairy solids, including wet or liquid dairy ingredients (e.g., whole milk, skim milk, yogurt, cream cheese, cream, and the like), dry dairy ingredients (e.g., powdered milk, non-fat dry milk, whey protein concentrate, cream cheese powder, dairy product solids, and the like), or any combination thereof. Dry dairy ingredients are particularly useful to control moisture content of the dough phase of a place-and-bake cake product.

As used herein, the term “solids” refers to components of an ingredient (e.g., egg or dairy) excluding water. Solids can be contributed by dry ingredients (e.g., a powder, such as dried egg whites, powdered milk, and the like), wet ingredients (e.g., whole egg, egg whites, milk, cream, yogurt, or the like), or a combination thereof. Solids can comprise any non-water ingredient, including, without limitation protein, fiber, sugar, minerals, fats, and the like.

The dough phase of a refrigerated or frozen place-and-bake cake product includes a leavening system in an amount of from about 0.4% to about 0.7% (e.g., about 0.55% to about 0.65%) by weight of the dough phase. As used herein, the term “leavening system” includes one or more components that react to leaven a dough before, during, or after baking. Leavening systems typically contain an acid and a base that react to leaven a dough. In some embodiments, a leavening system can contribute to browning during baking. Suitable components of a leavening system include, without limitation, sodium bicarbonate combined with one or more of sodium aluminum phosphate (SALP), sodium acid pyrophosphate (SAPP), glucono-delta-lactone (GDL).

The dough phase of a refrigerated or frozen place-and-bake cake product includes a moisture content of about 15% to about 25% by weight of the dough phase. Moisture content can be provided by added water and/or any ingredient included in a place-and-bake cake product. In some embodiments, at least a portion of the moisture content of a dough phase can be contributed by a fruit or vegetable puree or mash, a liquid egg ingredient, a liquid dairy ingredient, and/or a sugar syrup.

In some embodiments, the dough phase of a refrigerated or frozen place-and-bake cake product can include one or handleability modifiers. For example, in some embodiments, the dough phase of a refrigerated or frozen place-and-bake cake product can include an emulsifier, a potato starch, a soluble corn fiber, or any combination thereof. An emulsifier in a dough phase in an amount of from about 0.5% to about 2.5% (e.g., about 1% to about 2%) by weight of the dough phase can improve handleability in some embodiments. A potato starch or a soluble corn fiber, or a combination of potato starch and soluble corn fiber, can be included in a dough phase in an amount of up to 5% (e.g., up to 3%, or from about 1% to 3%) by weight of the dough phase.

In some embodiments, the dough phase of a refrigerated or frozen place-and-bake cake product can include additional ingredients, such as flavorants (e.g., salt, vanilla, fruit juice, or the like), colorants (e.g., fruit juice, dyes, cocoa powder, or the like), and/or humectants (e.g., glycerin). Such additional ingredients are typically included at minor levels (e.g., less than 5% each, or less than 2% each, or less than 10% combined, less than 5% combined, or less than 2% combined).

In some embodiments, an uncooked dough of a refrigerated or frozen place-and-bake cake product can have inclusions (e.g., dried fruit, nuts, seeds, chocolate pieces, candy pieces, and the like, or any combination thereof) in, on, and/or distributed throughout the dough phase. Particulates can be included in an amount of up to 25% (e.g., about 5% to about 20%, or about 10% to about 15%) by weight of the uncooked dough.

An uncooked dough for a place-and-bake cake product can be made by combining the above-recited components using any appropriate method and equipment. Preferably, gums, corn flour, and, if included, corn starch, are combined with water and/or wet ingredients (e.g., fruit or vegetable mash or puree, glycerin, and the like) to make a first mixture prior to making a second mixture by adding any other dry ingredients to ensure sufficient hydration of the gums, corn flour, and optional corn starch. In some embodiments, corn flour, wheat flour, corn starch, and gums can be combined as a dry mix prior to adding water and/or wet ingredients to make a first mixture. Preferably, oil and/or fat can be added to the second mixture. Particulates can be combined with other ingredients at any appropriate step. A batch mixer with a ribbon blender is particularly suitable for combining ingredients to make a dough phase. In some embodiments, temperature during mixing can be adjusted to facilitate mixing of ingredients. In some embodiments, a suitable mixing temperature can be a temperature where a solid fat included in the dough phase has at least 10% solid fat content (e.g., about 15% to about 40% SFC). In some embodiments, a suitable mixing temperature can be between about 60° F. to about 80° F. (e.g., about 65° F. to about 75° F.).

In some embodiments, an uncooked dough can be tested using a texture analyzer, and found to exhibit a peak positive force of at least 200 g (e.g., about 200 g to about 1500 g). A peak positive force of at least 200 g can coincide with good handleability of the uncooked dough. That is, an uncooked dough exhibiting a peak positive force of less than 200 g can be too soft to handle without significant deformation. On the other hand, a peak positive force above 1500 g can indicate that an uncooked dough will have reduced quality upon baking.

An uncooked dough can be portioned and/or shaped in any appropriate way. For example, in some embodiments, an uncooked dough can be portioned into balls or “pucks” that are about 20 g to about 40 g to produce individual serving-sized cakes or muffin tops upon baking. Larger or smaller portions can provide different serving sizes and/or numbers of servings per portion. In addition, portions can be shaped to achieve a desired shape upon baking. Uncooked dough in a puck shape can bake to produce a mounded shape that is particularly similar to a muffin top.

Portions of an uncooked dough can be packaged in any suitable package, and with any suitable number of portions in a package. For example, in some embodiments portions of uncooked dough can be packaged individually to provide a consumer flexibility as to how many portions they want to bake. In some embodiments, several portions can be packaged in a single package. In some embodiments, portions can be packaged on a disposable support surface, such as parchment paper, plastic film, paperboard, and the like. In some cases, portions that are packaged on a disposable support surface can adhere sufficiently to the support surface such that movement of the portions are limited within the package during storage, handling, and/or transport, yet are easy for a consumer to remove to place on a baking surface. In some embodiments, a disposable support surface can be suitable for use as a baking surface.

Although a place-and-bake cake product provided herein is suitable for being stored at refrigeration temperatures and is stable over a refrigerated shelf life of more than 2 months, in some embodiments, a place-and-bake cake product can be frozen during all or part of its shelf life. For example, a place-and-bake cake product can be frozen for transport to a retailer and then stored at refrigeration temperatures.

The following examples are intended to provide support for the described place-and-bake cake product, and are not intended to be limiting.

### Example 1

Uncooked dough for a place-and-bake cake product was made by combining ingredients as described above, and portions were placed on a disposable support surface, then refrigerated at 40° F. Samples of the place-and bake cake product were compared to a commercially available refrigerated place-and-bake fudge brownie product and a commercially available refrigerated place-and-bake sugar cookie product. The uncooked dough portions of each of the products were similarly sized and shaped prior to baking. Each of the products had similar handling characteristics at when equilibrated to 40° F. or 50° F.: each was firm enough to remove from a support surface without significant deformation and each adhered slightly to the support surface, yet was minimally sticky to the touch. Handling characteristics remained similar over a refrigerated shelf life of at least 21 days, and possibly even improving over shelf life.

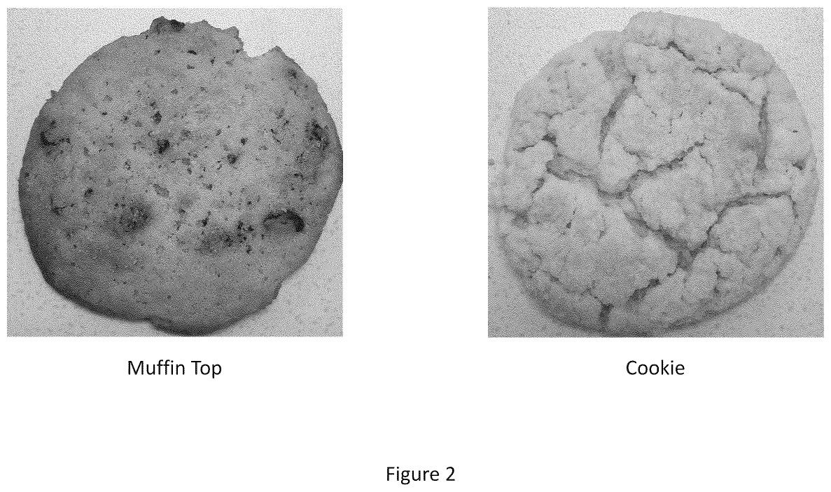

Upon baking, the place-and-bake cake product resulted in a baked good that was significantly different from the commercially available brownie and cookie products. FIG. 1 shows a comparison of crumb structure, where the cake product (in the form of a muffin top) exhibits an open crumb structure, while the brownie and cookie products are denser. The place-and-bake product also formed a more domed structure than either of the cookie or brownie products. FIG. 2 shows that the place-and-bake product developed a smooth surface marked by pores formed from bubbles produced during baking, while the sugar cookie product showed a cracked surface. Structures the baked goods made from each product were also stable for each product over at least 21 days at 40° F.

Texture of baked goods made from each of the place-and-bake products was measured using a texture analyzer. Briefly, at least 12 samples of each product were baked until fully cooked. Following baking, each sample was allowed to cool to room temperature. Each sample was cut into a 1.5 inch circle taken from the center of the product. Because the cookie product baked to a much thinner baked good, samples of the cookie product were stacked to approximate the height of the cake and brownie finished products for testing using the texture analyzer. Each sample was poked with the texture analyzer twice. The settings for the texture analyzer were set as follows for the pokes:
Pre-test speed: 1.00 mm/sec
Test speed: 5.00 mm/sec
Post-test speed: 5.00 mm/sec
Target mode: strain
Strain: 50%
Time: 5.00 seconds
Trigger type: Auto (Force)
Trigger force: 5.0 g

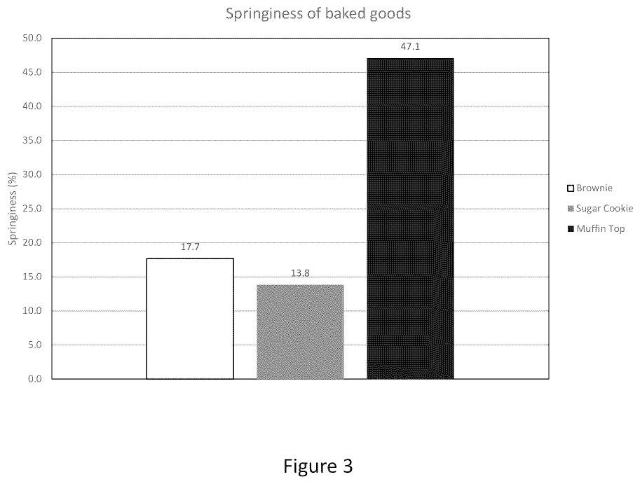

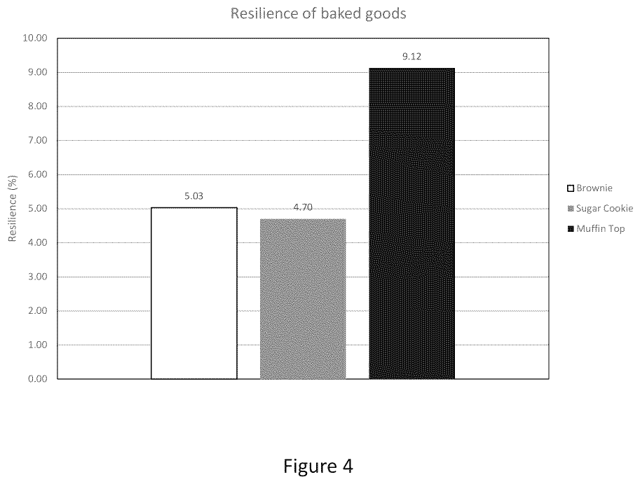

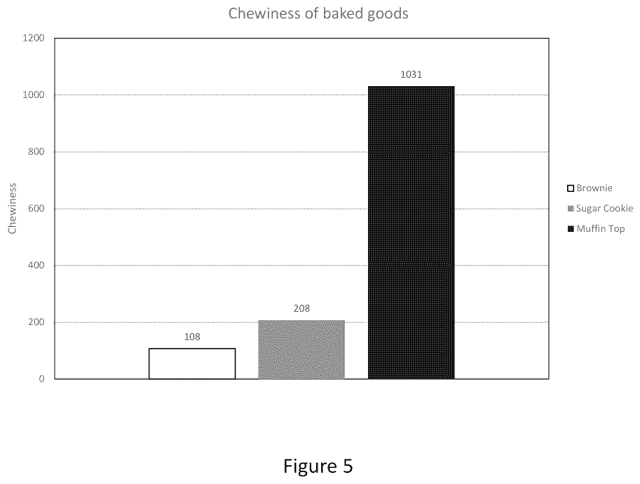

Springiness, Resilience, and Chewiness of each product were calculated to approximate features of an eating experience for the products. The graphs in FIGS. 3, 4, and 5 show the results. Generally, the place-and-bake cake product (in the form of a muffin top) was significantly more springy, resilient, and chewy than the cookie and brownie products, indicating an eating experience that is much more cake-like.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A refrigerated or frozen place-and-bake cake product, the product comprising portions of an uncooked dough with a water activity of less than 0.85, the uncooked dough having a dough phase in an amount of about 75% to 100%, including:
a. a flour component, the flour component comprising wheat flour in an amount of about 11% to about 22% by weight of the dough phase and corn flour in an amount of about 6.5% to about 13% by weight of the dough phase;
b. a pregelatinized starch component in an amount of about 0.4% to about 3.3% by weight of the dough phase;
c. a gum component in an amount of at least 0.07% to about 0.33% by weight of the dough phase, the gum component comprising xanthan gum and a second gum;
d. a fat content of from about 12% to about 20% by weight of the dough phase, the fat content comprising a fat that is solid at room temperature;
e. sucrose in an amount of at least 15% by weight of the dough phase;
f. an egg solids component in an amount of from about 0.8% to about 2.4% by weight of the dough phase, the egg solids component comprising egg white solids in an amount of about 0.7% to about 1.5% by weight of the dough phase;
g. a dairy solids component in an amount of about 3% to about 10% by weight of the dough phase;
h. a leavening system in an amount of from about 0.4% to about 0.7% by weight of the dough phase; and
i. a moisture content of from about 15% and about 25% by weight of the dough phase.

2. The product of claim 1, wherein the second gum comprises carrageenan or locust bean gum.

3. The product of claim 2, wherein the second gum comprises carrageenan and locust bean gum.

4. The product of claim 1, wherein the dough phase further comprises potato starch or soluble corn fiber.

5. The product of claim 4, wherein the potato starch or soluble corn fiber are included in an amount of up to 3% by weight of the dough phase.

6. The product of claim 1, wherein the uncooked dough comprises particulates in an amount of up to 20% by weight of the uncooked dough distributed throughout the dough phase.

7. The product of claim 1, wherein the portions are from about 20 g to about 40 g.

8-10. (canceled)

11. The product of claim 1, wherein the xanthan gum and the second gum are included at a weight ratio of about 1:2 to about 1:3 xanthan gum to second gum.

12. The product of claim 11, wherein the second gum comprises carrageenan gum and locust bean gum at a weight ratio of about 1:0.5 to 1:1 carrageenan gum to locust bean gum.

13. A refrigerated or frozen place-and-bake cake product, the product comprising portions of an uncooked dough with a water activity of less than 0.85 the uncooked dough having a dough phase in an amount of about 75% to 100%, including:
a. a flour component, the flour component comprising wheat flour in an amount of about 11% to about 22% by weight of the dough phase and corn flour in an amount of about 6.5% to about 13% by weight of the dough phase;
b. a fruit or vegetable mash or puree in an amount of about 5% to about 18% by weight of the dough phase;
c. a gum component in an amount of at least 0.07% to about 0.33% by weight of the dough phase, the gum component comprising xanthan gum and a second gum;
d. a fat content of from about 12% to about 20% by weight of the dough phase, the fat content comprising a fat that is solid at room temperature;
e. sucrose in an amount of at least 15% by weight of the dough phase;
f. an egg solids component in an amount of from about 0.8% to about 2.4% by weight of the dough phase, the egg solids component comprising egg white solids in an amount of about 0.7% to about 1.5% by weight of the dough phase;
g. a dairy solids component in an amount of about 3% to about 10% by weight of the dough phase;
h. a leavening system in an amount of from about 0.4% to about 0.7% by weight of the dough phase; and
i. a moisture content of from about 15% and about 25% by weight of the dough phase.

14. The product of claim 13, wherein at least a portion of the moisture content is provided by the fruit or vegetable mash or puree.

15. The product of claim 14, wherein the fruit or vegetable mash or puree comprises banana, zucchini, apple, or pumpkin.

16. A method of making a refrigerated or frozen place-and-bake cake product, the method comprising:
a. combining a flour component and a gum component with wet ingredients to form a first mixture, where the flour component comprises wheat flour and corn flour, the gum component comprises xanthan gum and a second gum, and the wet ingredients comprise water, a fruit or vegetable mash or puree, or any combination thereof;
b. combining the first mixture with dry ingredients to form a second mixture, the second mixture comprising sucrose, an egg solids component, a dairy solids component, and a leavening system;
c. combining the second mixture with a fat that is solid at room temperature to produce an uncooked dough having a dough phase with a water activity of less than 0.85, the dough phase comprising:
i. wheat flour in an amount of about 11% to about 22% by weight of the dough phase;
ii. corn flour in an amount of about 6.5% to about 13% by weight of the dough phase;
iii. a pregelatinized starch component or the fruit or vegetable puree or mash, wherein if included, the pregelatinized starch component is included in an amount of about 0.4% to about 3.3% by weight of the dough phase;
and if included, the fruit or vegetable puree or mash is included in an amount of about 5% to about 18% by weight of the dough phase;
iv. the gum component in an amount of at least 0.07% to about 0.33% by weight of the dough phase;
v. a fat content of from about 12% to about 20% by weight of the dough phase, the fat content comprising the fat that is solid at room temperature;
vi. sucrose in an amount of at least 15% by weight of the dough phase;
vii. the egg solids component in an amount of from about 0.8% to about 2.4% by weight of the dough phase, the egg solids component comprising egg white solids in an amount of about 0.7% to about 1.5% by weight of the dough phase;
viii. the dairy solids component in an amount of about 3% to about 10% by weight of the dough phase;
ix. the leavening system in an amount of from about 0.4% to about 0.7% by weight of the dough phase; and
x. a moisture content of from about 15% and about 25% by weight of the dough phase;
d. forming the uncooked dough into portions;
e. packaging the portions; and
f. refrigerating or freezing the portions to produce the refrigerated or frozen place-and-bake cake product.

17. The method of claim 16, wherein at least one of the first mixture comprises corn starch and the first mixture comprises glycerin.

18. (canceled)

19. The method of claim 16, wherein the dry ingredients used in the second mixture comprises the pregelatinized starch component.

20. The method of claim 16, wherein one or more of the combining steps are performed at a temperature of about 60° F. to about 80° F.

21. The method of claim 16, wherein the uncooked dough further comprises particulates distributed throughout the dough phase.

22. The method of claim 21, wherein the particulates are combined with the first mixture to make the second mixture.

23. The method of claim 21, wherein the particulates are combined with the second mixture before combining with the fat that is solid at room temperature.

24. The method of claim 21, wherein the particulates are combined with the dough phase to make the uncooked dough.

25-26. (canceled)
